(19) United States
(12) Patent Application Publication
(10) Pub. No.: US 2002/0194756 A1
(43) Pub. Date: Dec. 26, 2002

(54) Portable distress signaling device

(76) Inventor: Donald Charles Osborne, Oliver (CA)

Correspondence Address: ANTONY C. EDWARDS, SUITE 800, 1708 DOLPHIN AVENUE, KELOWNA, BC, V1Y 9S4, CA

(21) Appl. No.: 10/176,073

(22) Filed: Jun. 21, 2002

(30) Foreign Application Priority Data
Jun. 26, 2001 (CA) 2,350,971

(51) Int. Cl. G09F 1/00

(52) U.S. Cl. 40/124.02; 340/815.4; 340/815.55; 340/815.73

(57) ABSTRACT

The signal device includes a housing containing a light and having a front face adapted to receive, in removably mounted engagement thereon, a first message screen selected from a group of message screens. Each message screen of the group of message screens is preferably a substantially planar sheet permitting the passage of light therethrough when mounted in the front face and backlit by the light. The first message screen has a first distress message formed thereon which is illuminated when the message screen is backlit by the light. Each message screen of the group of message screens has a different distress message for communication by the backlighting by the light so that a user may select an appropriate distress message by selecting the corresponding message screen for mounting onto the front face. The light is activated by a switch mounted to the housing and cooperating with a power supply.

### CROSS REFERENCE TO RELATED APPLICATION

This application claims priority from Canadian Patent Application No. 2,350,971 filed Jun. 26, 2001 entitled Medi-Lert.

### FIELD OF THE INVENTION

This invention relates to the field of self-contained, portable distress signaling devices and in particular to a signaling device which may be positioned adjacent to the inside of a window of either a vehicle or dwelling to attract the attention, through illumination and acoustic signals, to the need for assistance.

### BACKGROUND OF THE INVENTION

A situation where assistance is required may be encountered either at home or while travelling. Persons in the nearby vicinity are most likely to be capable of providing assistance provided the need for assistance is clearly evident. The distress signaling device of the present invention is capable of providing both a visual and audible signal to attract the attention of those nearby to the need for assistance. The invention provides an illuminated faceplate having translucent lettering or illustrations indicating the general type of assistance required.

In the situation of a vehicle breakdown, one may be fearful of leaving the relative safety of the vehicle. With the distress signaling device of the present invention on board, activated and positioned in a vehicle window, passers-by will be alerted to the need for a specific type of assistance and can either immediately render that assistance or notify those more qualified to provide that assistance. In the home, or in a parked recreational vehicle or camper or mobile home, when the device is activated and placed in a window, neighbours will be summoned to provide assistance and where emergency personnel are enroute, the visual sign will act as a beacon so that the dwelling may be quickly located.

An object of this invention is to provide distress signaling device, which is lightweight, compact and through both illumination and acoustic signals will alert persons in the vicinity to the need for assistance.

A further object of this invention is to provide a distress signaling device which can be operated through electrical power generated by either an internal battery, an outlet such as a cigarette lighter accessing the 12 volt automobile power supply or the 120 volt household current.

A further object of this invention is to provide a device which will signify the category of emergency assistance required by having easily exchangeable message face plates containing colored translucent images or lettering.

A further object of this invention is to provide a distress signaling device where the internal source of illumination may be either an incandescent, fluorescent or high intensity strobe light which, upon activation, will back-light a translucent message faceplate.

### SUMMARY OF THE INVENTION

The present invention is a portable, electrically self contained lighted sign for use in units such as RV's, trailers, mobile homes, house boats, vans, campers etc. It can be placed in any of the unit's windows as an attention attracting, flashing sign and audible alarm such as a siren, buzzer etc. whose purpose is to draw the attention of passers by and/or potential rescue persons, alerting them of an emergency condition existing in or on the premises where the sign is displayed and energized. The message panel mounted in the housing can be changed, to reflect a number of emergency conditions, such as medical, police, fire etc. The housing can also incorporate a connector for connections to a remote horn, bell or other sound alarm to get further attraction. The attention/attraction lighting in behind the message panel or sign may include a brightly lit background and a flashing or strobe light or backmounted LEDs shining through, or a base mounted light source shining upwardly through a transparent, translucent or opaque planar medium for example having engraved text, engraved at forty-five degree sloping angles to reflect light transmitted through the panel outwardly of the face of the panel. The present invention is manually operated and may be in one embodiment primarily powered from the RV's battery through a cigarette lighter or other vehicle battery outlet. A battery adapter may be used for power from other sources.

The distress signaling device of the present invention may also be described as including a housing, at least one exchangeable message faceplate and preferably a selection of such faceplates, an internal lighting source, and an electrical power source. An acoustical signaling device such as piezoelectric siren may be stored within the device, ready for remote deployment, and operable by the activating power source of the signaling device. Easily accessible switches for controlling the operation of the components of the signaling device may be positioned on one side edge of the housing.

The housing may be formed from plastic or the like material and may have a solid back or first face with integrally formed opposed end or second faces bent generally at right angles to the back face. The distal or terminal edge of each of the opposed second end faces may be further bent at right angles so as to form or define a third face or frame which extend, in a general coplanar aspect toward each other so as to define a faceplate receiving frame.

Oppositely disposed first and second sides are mounted between the end faces forming an open-faced container or housing. First longitudinal side edge when secured in place terminates short of engagement with the edge surface of the adjacent third faces, so that A gap is left between one of the sides and the faceplate receiving frame. A translucent message faceplate may then be slid into the gaps so as to be removably mounted in the frame, resting against the opposite side of the housing. A pair of guides form a pair of opposed facing channels which guide and stain the faceplate in the frame.

A battery, and a source of illumination, such as a strobe light are mounted to the back face so as to be contained within the housing. Suitable control switches and receptacles for both remote power input and acoustical output are conveniently located on one side of the housing. The housing may take a number of shapes, however a preferred shape is rectangular so that the housing may rest on one of its sides.

Thus the signal device of the present invention may also be characterized as including a housing containing a light and having a front face adapted to receive, in removably mounted engagement thereon, a first message screen selected from a group of message screens. Each message screen of the group of message screens is preferably a substantially planar sheet permitting the passage of light therethrough when mounted in the front face and backlit by the light. The first message screen has a first distress message formed thereon which is illuminated when the message screen is backlit by the light. Each message screen of the group of message screens has a different distress message for communication by the backlighting by the light so that a user may select an appropriate distress message by selecting the corresponding message screen for mounting onto the front face. The light is activated by a switch mounted to the housing and cooperating with a power supply.

The housing may be a rigid rectangular housing defining a rectangular frame on the front face. Each message screen may therefore be a substantially rigid, correspondingly rectangular shape. The frame may include an opposed facing pair of side rails adapted for sliding fitment of corresponding side edges of each message screen.

The housing preferably has a base adapted to provide a stable support for the housing. The pair of side rails are preferably disposed for generally vertical sliding engagement of each message screen into sliding fitment to provide for ease of replacement and interchanging of each message screen when the base is placed on a substantially horizontal rigid surface. Releasable locking means may be provided for releasably retaining each message screen when mounted in the frame.

The housing may define a storage cavity therein behind the front face wherein removal of the message screen from the front face provides access to the storage cavity. An acoustic signaling means may be stored in the storage cavity, is adapted for removal therefrom for mounting remote from the housing in electrical cooperation with the light switch.

The light may include a constant illuminating first light source and intermittently illuminating second light source which are activated simultaneously by the switch. The second light source may be a strobe light for strobed flashing of the backlighting.

### BRIEF DESCRIPTION OF THE DRAWINGS

FIG. 1, is an isometric view of the portable distress-signaling device of the present invention.

FIG. 2 is a front view of the device shown in FIG. 1 with one form of exchangeable message faceplate partially installed.

FIG. 3 is a sectional view taken on line 3-3 of FIG. 2.

FIG. 4 is a front elevation view of an alternative form of portable distress signaling device with the message faceplate removed.

FIG. 5 schematically illustrates one form of electrical diagram with an external acoustic signaling device.

FIG. 6 is a front elevation view of a message panel having LEDs backmounted thereon according to one embodiment of the present invention

FIG. 6a is an enlarged perspective view of a portion of FIG. 6.

FIG. 7 is one embodiment of a base-lit version of the signaling device of the present invention.

FIG. 8 is a further embodiment of a base-lit version of the signaling device of the present invention.

FIG. 8a is a sectional view along line 8a-8a in FIG. 8 showing forty-five degree engraving of text on the message plate.

### DETAILED DESCRIPTION OF EMBODIMENTS OF THE INVENTION

With reference to the drawing figures, wherein similar characters of reference denote corresponding parts in each view, the signaling device 10 has a back face 12 and integrally formed end faces 14 which extend generally at right angles to face 12. Faces 14 are further bent to extend generally at right angles to face 12 in generally coplanar alignment with, and toward, each other forming a pair of opposed facing inturned lips 16. Lips 16 define a faceplate receiving frame. First and second side edges 20 and 22 of the housing respectively are mounted or formed between end faces 14, to thereby form an open-faced rectangular housing. Side 20 terminates short of engagement with the adjacent portion of inturned lip 16 creating a gap 24 between lip 16 and side 20 to permit insertion of a translucent message faceplate 26. A projecting tab 20a is formed medially on side 20 so as to engage recess 26a formed on faceplate 26. Message faceplate 26 is retained in the frame, generally in parallel alignment with back face 12, by means of a pair of guide strips 30 affixed to each end face 14 of the housing by gluing or the like. Strips 30 are mounted in parallel to lip 16 to form guide channels for the faceplate. A projecting tab 26b formed on faceplate 26 engages a corresponding slot 22a formed in second side 22.

Message faceplate 26 may be category specific for the type of assistance required. As an example, lettering or symbols may indicate the need for fuel or mechanical assistance in the case of the traveler, or, in the case of the resident, may indicate the need for emergency medical, 911 or fire suppression assistance. The text of the message may be painted onto the surface of the faceplate for example using translucent ink so as to retain the color of the ink when backlit.

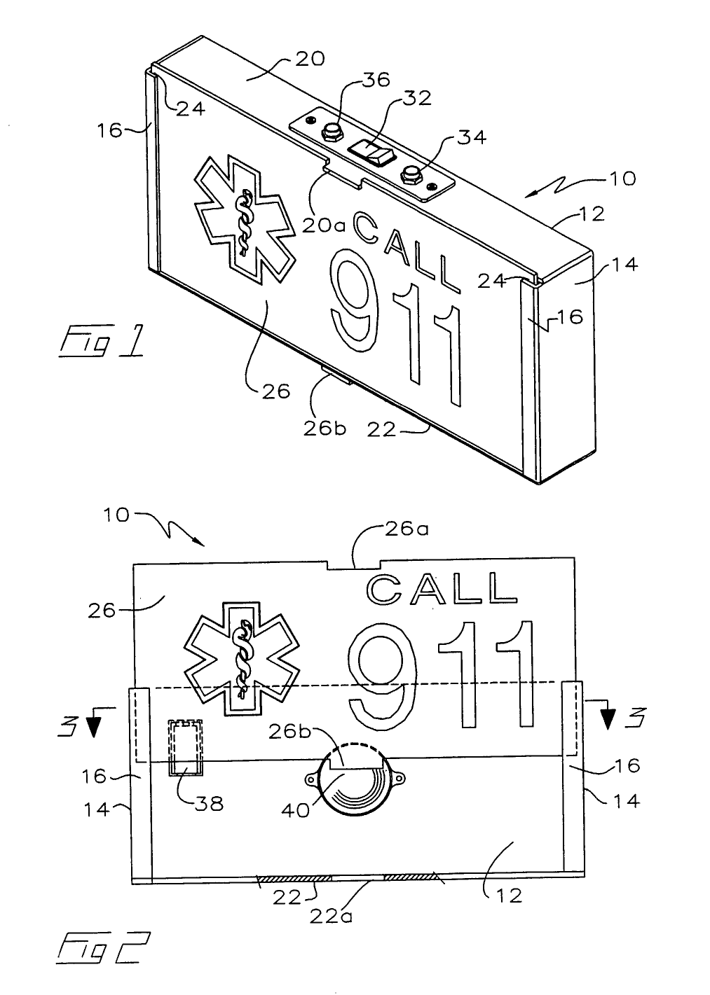

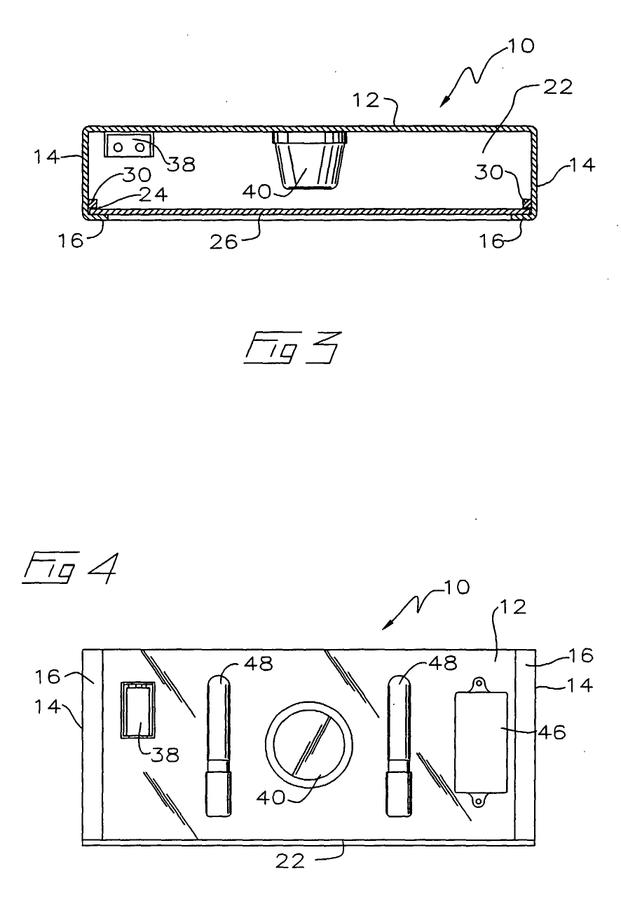

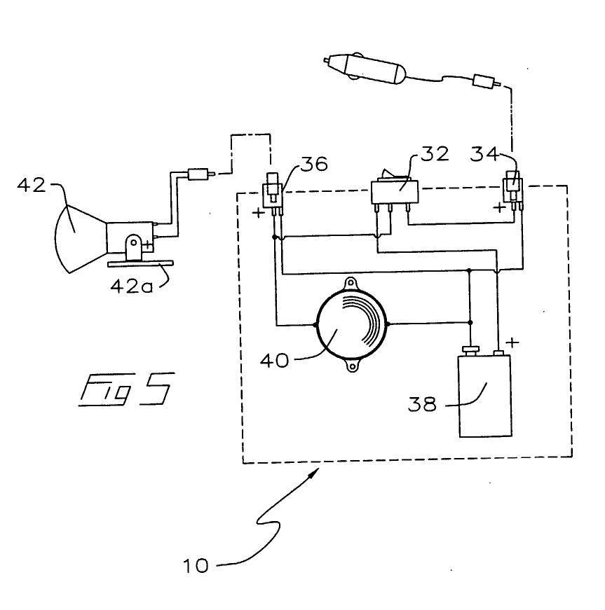

Side 20 of signaling device 10, that is, the top side in FIG. 1, has mounted thereon easily accessible control features, for example on/off switch 32, auxiliary power input switch 34 and remote alarm output switch 36. Contained within device 10 are a battery 38 and a light 40. A horn 42 may also be stored in the housing ready for removal for remote use. Horn 42 is ready for remote operation when connected through alarm output switch 36. Horn 42 may have a magnetic or otherwise releasably mountable base 42a to permit attachment of the horn to, for example, the exterior of a vehicle for better transmission of the acoustic signal. Light 40 may be incandescent or a high intensity strobe. Toggling switch 32 sends a trigger voltage out through remote alarm output 36 to interface with an external or remote electronic monitoring system triggered by the voltage trigger output, for example, such as those which automatically alert other monitoring or alarm or medical services for example. The external device may be any external device which may be triggered, keyed or otherwise enabled by the voltage output, and which may be enabled by the toggling of switch 32, including, but not limited to, a car horn, GPS monitor, cell phone autodial as would or will be known to one skilled in the art.

Alternatively, device 10 may contain a direct current ballast 46 for the operation of one or more mini-fluorescent tubes 48. In the alternative design of FIGS. 6 and 6a, message faceplate 26 is a translucent, for example lightly smoke colored panel, having back-mounted thereon a plurality of light emitting diodes (LEDs) as an alternative to the use of a strobe or other backlighting. The LEDs remain invisible to the casual observer until lit and are supported on a circuit board (not shown) as would be known to one skilled in the art. The LEDs are mounted in arrays which collectively form or outline the letters of the desired text of the message to be displayed.

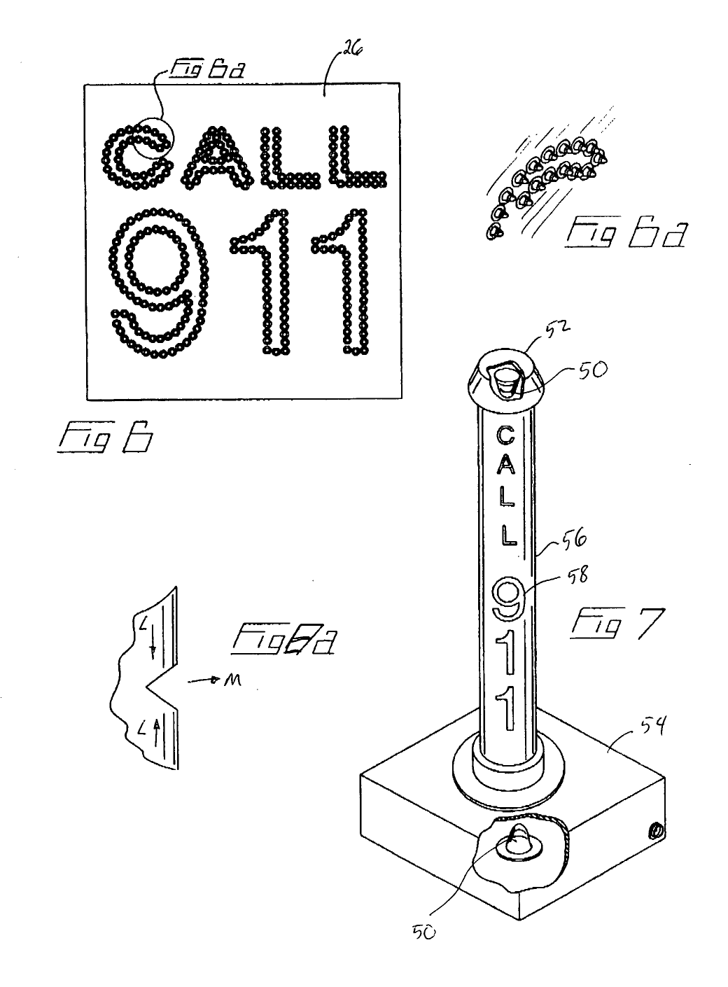

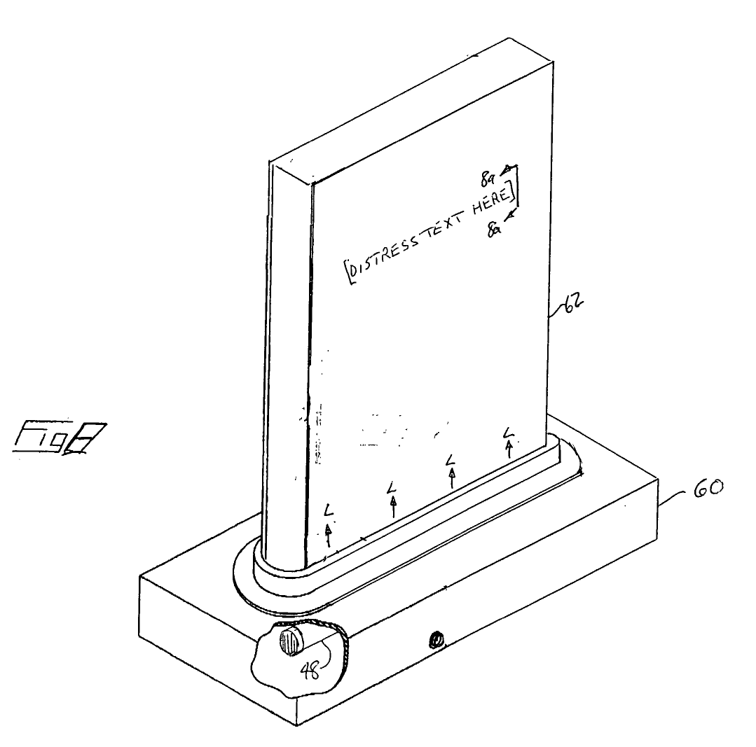

In the embodiments of FIGS. 7 and 8, a translucent rigid medium such as a polycarbonate or transparent acrylic such as Lucite™ is illuminated by, for example, a base mounted, top-mounted or side-mounted light source or sources. Thus in FIG. 7, top and bottom LEDs 50 are mounted respectively in cap 52 and base 54 so as to light translucent rod 56. Distress message lettering 58 is engraved in rod 56 using, for example a triangular cross-section forty-five degree sided engraving such as seen in FIG. 8a so that light in direction L is reflected or dispersed from the engraving in direction M. Similarly in FIG. 8 fluorescent mini-tube 48 is mounted in, so as to extend along, hollow base 60. Light from tube 48 is directed upwardly in translucent block 62 in direction L through the exposed lower face of the block (not shown) protruding into base 60.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A signal device comprising:
a housing containing a light and having a front face adapted to receive, in removably mounted engagement thereon, a first message screen selected from a group of message screens,
wherein each message screen of said group of message screens is a substantially planar sheet permitting the passage of light therethrough when mounted in said front face and illuminated by said light, said first message screen having a first distress message formed thereon which is illuminated when said message screen is illuminated by said light, and said each message screen of said group of message screens having a different distress message for communication by said illuminating by said light so that a user may select an appropriate distress message by selecting the corresponding said message screen for mounting onto said front face,
said light activated by a switch mounted to said housing and cooperating with a power supply.

2. The device of claim 1 wherein said housing is a rigid rectangular housing defining a rectangular frame on said front face, and wherein said each message screen is a substantially rigid correspondingly rectangular shape and wherein said illuminating backlighting.

3. The device of claim 2 wherein said frame includes an opposed facing pair of side rails adapted for sliding fitment of corresponding side edges of said each message screen.

4. The device of claim 3 wherein said housing has a base adapted to provide a stable support for said housing and wherein said pair of side rails are disposed for generally vertical sliding engagement of said each message screen into said sliding fitment to provide for ease of replacement and interchanging of said each message screen when said base is placed on a substantially horizontal rigid surface.

5. The device of claim 4 wherein said each message screen is translucent.

6. The device of claim 4 wherein said first distress message is “call 911”.

7. The device of claim 4 wherein said housing further comprises releasable locking means for releasably retaining said each message screen when mounted in said frame.

8. The device of claim 4 wherein said housing includes an upper surface opposite said base and wherein said switch is mounted on said upper surface.

9. The device of claim 1 wherein said housing defines a storage cavity therein behind said front face wherein removal of said first message screen from said front face provides access to said storage cavity, and wherein an acoustic signaling means is stored in said storage cavity and is adapted for removal therefrom for remote mounting remote from said housing in electrical cooperation with said switch.

10. The device of claim 1 wherein said light includes a constant illuminating first light source and intermittently illuminating second light source which are activated simultaneously by said switch.

11. The device of claim 10 wherein said second light source is a strobe light for flashing said backlighting.

12. The device of claim 1 further including an external power-out jack wherein said switch, when activated, simultaneously supplies power to said jack for activating an external device electrically connected to said jack, whereby if the external device is a broadcast device, a monitoring service may be notified of actuation of said switch.

13. The device of claim 1 wherein said message screen is a rigid translucent block having said message engraved thereon, and wherein said illuminating is illumination of an edge surface of said block.

14. The device of claim 13 further comprising a base, said block mounted in said base, and wherein said illumination is base illumination of said block.

15. The device of claim 13 wherein said message is engraved by engraving having forty-five degree angled sides.
